(19) United States
(12) Patent Application Publication
(10) Pub. No.: US 2005/0080891 A1
(43) Pub. Date: Apr. 14, 2005

(54) Maintenance unit architecture for a scalable internet engine

(76) Inventor: David M. Cauthron, Tomball, TX (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/929,776

(22) Filed: Aug. 30, 2004

Related U.S. Application Data
(60) Provisional application No. 60/498,447, filed on Aug. 28, 2003.
(60) Provisional application No. 60/498,493, filed on Aug. 28, 2003.
(60) Provisional application No. 60/498,460, filed on Aug. 28, 2003.

(51) Int. Cl. G06F 15/173

(52) U.S. Cl. 709/223

(57) ABSTRACT

A scalable Internet engine that dynamically reassigns server operations in the event of a failure of an ADSS (Adaptive Data Storage System) server. A first and a second ADSS server mirror each other and include corresponding databases with redundant data, domain host control protocol servers, XML interfaces and watchdog timers. The ADSS servers are communicatively coupled to at least one engine operating system and a storage switch; the storage switch being coupled to at least one storage element. The second ADSS server detects, via a heartbeat monitoring algorithm, the failure of the first ADSS server and automatically initiates a fail over action to switch over functions to the second ADSS server. The architecture also includes a supervisory data management arrangement that includes a plurality of reconfigurable blade servers coupled to a star configured array of data management units.

### PRIORITY CLAIM

The present application claims priority to U.S. Provisional Application No. 60/498,447 entitled “MAINTENANCE UNIT ARCHITECTURE FOR A SCALABLE INTERNET ENGINE,” filed Aug. 28, 2003; U.S. Provisional Application No. 60/498,493 entitled “COMPUTING HOUSING FOR BLADE WITH NETWORK SWITCH,” filed Aug. 28, 2003; and U.S. Provisional Application No. 60/498,460 entitled, “iSCSI BOOT DRIVE SYSTEM AND METHOD FOR A SCALABLE INTERNET ENGINE,” filed Aug. 28, 2003, the disclosures of which are hereby incorporated by reference. Additionally, the present application incorporates by reference U.S. patent application Ser. No. 09/710,095 entitled “METHOD AND SYSTEM FOR PROVIDING DYNAMIC HOSTED SERVICE MANAGEMENT ACROSS DISPARATE ACCOUNTS/SITES,” filed Nov. 10, 2000.

### FIELD OF THE INVENTION

The present invention relates generally to the field of data processing business practices. More specifically, the present invention relates to a method and system for dynamically and seamlessly reassigning server operations from a failed server to another server without disrupting the overall service to an end user.

### BACKGROUND OF THE INVENTION

The explosive growth of the Internet has been driven to a large extent by the emergence of commercial service providers and hosting facilities, such as Internet Service Providers (ISPs), Application Service Providers (ASPs), Independent Software Vendors (ISVs), Enterprise Solution Providers (ESPs), Managed Service Providers (MSPs) and the like. Although there is no clear definition of the precise set of services provided by each of these businesses, generally these service providers and hosting facilities provide services tailored to meet some, most or all of a customer's needs with respect to application hosting, site development, e-commerce management and server deployment in exchange for payment of setup charges and periodic fees. In the context of server deployment, for example, the fees are customarily based on the particular hardware and software configurations that a customer will specify for hosting the customer's application or website. For purposes of this invention, the term “hosted services” is intended to encompass the various types of these services provided by this spectrum of service providers and hosting facilities. For convenience, this group of service providers and hosting facilities shall be referred to collectively as Hosted Service Providers (HSPs).

Commercial HSPs provide users with access to hosted applications on the Internet in the same way that telephone companies provide customers with connections to their intended caller through the international telephone network. HSPs use servers to host the applications and services they provide. In its simplest form, a server can be a personal computer that is connected to the Internet through a network interface and that runs specific software designed to service the requests made by customers or clients of that server. For all of the various delivery models that can be used by HSPs to provide hosted services, most HSPs will use a collection of servers that are connected to an internal network in what is commonly referred to as a “server farm,” with each server performing unique tasks or the group of servers sharing the load of multiple tasks, such as mail server, web server, access server, accounting and management server. In the context of hosting websites, for example, customers with smaller websites are often aggregated onto and supported by a single web server. Larger websites, however, are commonly hosted on dedicated web servers that provide services solely for that site.

As the demand for Internet services has increased, there has been a need for ever-larger capacity to meet this demand. One solution has been to utilize more powerful computer systems as servers. Large mainframe and midsize computer systems have been used as servers to service large websites and corporate networks. Most HSPs tend not to utilize these larger computer systems because of the expense, complexity, and lack of flexibility of such systems. Instead, HSPs have preferred to utilize server farms consisting of large numbers of individual personal computer servers wired to a common Internet connection or bank of modems and sometimes accessing a common set of disk drives. When an HSP adds a new hosted service customer, for example, one or more personal computer servers are manually added to the HSP server farm and loaded with the appropriate software and data (e.g., web content) for that customer. In this way, the HSP deploys only that level of hardware required to support its current customer level. Equally as important, the HSP can charge its customers an upfront setup fee that covers a significant portion of the cost of this hardware.

For HSPs, numerous software billing packages are available to account and charge for these metered services, such as XaCCT from rens.com and HSP Power from inovaware.com. Other software programs have been developed to aid in the management of HSP networks, such as IP Magic from lightspeedsystems.com, Internet Services Management from resonate.com and MAMBA from luminate.com. By utilizing this approach, the HSP does not have to spend money in advance for large computer systems with idle capacity that will not generate immediate revenue for the HSP. The server farm solution also affords an easier solution to the problem of maintaining security and data integrity across different customers than if those customers were all being serviced from a single larger mainframe computer. If all of the servers for a customer are loaded only with the software for that customer and are connected only to the data for that customer, security of that customer's information is insured by physical isolation. The management and operation of an HSP has also been the subject of articles and seminars, such as Hursti, Jani, “Management of the Access Network and Service Provisioning,” Seminar in Internetworking, Apr. 19, 1999. An example of a typical HSP offering various configurations of hardware, software, maintenance and support for providing commercial levels of Internet access and website hosting at a monthly rate can be found at rackspace.com.

When a customer wants to increase or decrease the amount of services being provided for their account, the HSP will manually add or remove a server to or from that portion of the HSP server farm that is directly cabled to the data storage and network interconnect of that client's website. In the case where services are to be added, the typical process would be some variation of the following: (a) an order to change service level is received from a hosted service customer, (b) the HSP obtains new server hardware to meet the requested change, (c) personnel for the HSP physically install the new server hardware at the site where the server farm is located, (d) cabling for the new server hardware is added to the data storage and network connections for that site, (e) software for the server hardware is loaded onto the server and personnel for the HSP go through a series of initialization steps to configure the software specifically to the requirements of this customer account, and (f) the newly installed and fully configured server joins the existing administrative group of servers providing hosted service for the customer's account. In either case, each server farm is assigned to a specific customer and must be configured to meet the maximum projected demand for services from that customer account.

Originally, it was necessary to reboot or restart some or all of the existing servers in an administrative group for a given customer account in order to allow the last step of this process to be completed because pointers and tables in the existing servers would need to be manually updated to reflect the addition of a new server to the administrative group. This requirement dictated that changes in server hardware could only happen periodically in well-defined service windows, such as late on a Sunday night. More recently, software, such as Microsoft® Windows® 2000, Microsoft® Cluster Server, Oracle Parallel Server, Windows® Network Load Balancing Service (NLB), and similar programs have been developed and extended to automatically allow a new server to join an existing administrative group at any time rather than in these well-defined windows.

Such servers integration is useful, especially if one service group is experiencing a heavy workload and another service group is lightly loaded. In that case, it is possible to switch a server from one service group to another. U.S. Pat. No. 5,951,694 describes a software routine executing on a dedicated administrative server that uses a load balancing scheme to modify the mapping table to insure that requests for that administrative group are more evenly balanced among the various service groups that make up the administrative group.

Numerous patents have described techniques for workload balancing among servers in a single cluster or administrative groups. U.S. Pat. No. 6,006,259 describes software clustering that includes security and heartbeat arrangement under control of a master server, where all of the cluster members are assigned a common IP address and load balancing is preformed within that cluster. U.S. Pat. Nos. 5,537,542, 5,948,065 and 5,974,462 describe various workload-balancing arrangements for a multi-system computer processing system having a shared data space. The distribution of work among servers can also be accomplished by interposing an intermediary system between the clients and servers. U.S. Pat. No. 6,097,882 describes a replicator system interposed between clients and servers to transparently redirect IP packets between the two based on server availability and workload.

One weakness in managing server systems and the physical hardware that make up the computer systems is the possibility of hardware component failure. In this instance, server systems are known to go into a failover mode. Failover is a backup operational mode in which the functions of a system component (such as a processor, server, network, or database, for example) are assumed by secondary system components when the primary component becomes unavailable through either failure or scheduled down time. The procedure usually involves automatically offloading tasks to a standby system component so that the procedure is as seamless as possible to the end user. Within a network, failover can apply to any network component or system of components, such as a connection path, storage device, or Web server.

One approach to automatically compensate for the failure of a hardware component within a computer network is described in U.S. Pat. No. 5,615,329 and includes a redundant hardware arrangement that implements remote data shadowing using dedicated separate primary and secondary computer systems where the secondary computer system takes over for the primary computer system in the event of a failure of the primary computer system. The problem with these types of mirroring or shadowing arrangements is that they can be expensive and wasteful, particularly where the secondary computer system is idled in a standby mode waiting for a failure of the primary computer system.

U.S. Pat. No. 5,696,895 describes another solution to this problem in which a series of servers each run their own tasks, but each is also assigned to act as a backup to one of the other servers in the event that server has a failure. This arrangement allows the tasks being performed by both servers to continue on the backup server, although performance will be degraded. Other examples of this type of solution include the Epoch Point of Distribution (POD) server design and the USI Complex Web Service. The hardware components used to provide these services are predefined computing pods that include load-balancing software, which can also compensate for the failure of a hardware component within an administrative group. Even with the use of such predefined computing pods, the physical preparation and installation of such pods into an administrative group can take up to a week to accomplish.

All of these solutions can work to automatically manage and balance workloads and route around hardware failures within an administrative group based on an existing hardware computing capacity; however, few solutions have been developed that allow for the automatic deployment of additional hardware resources to an administrative group. If the potential need for additional hardware resources within an administrative group is known in advance, the most common solution is to pre-configure the hardware resources for an administrative group based on the highest predicted need for resources for that group. While this solution allows the administrative group to respond appropriately during times of peak demand, the extra hardware resources allocated to meet this peak demand are underutilized at most other times. As a result, the cost of providing hosted services for the administrative group is increased due to the underutilization of hardware resources for this group.

Although significant enhancements have been made to the way that HSPs are managed, and although many programs and tools have been developed to aid in the operation of HSP networks, the basic techniques used by HSPs to create and maintain the physical resources of a server farm have changed very little. It would be desirable to provide a more efficient way of operating an HSP that could improve on the way in which physical resources of the server farm are managed.

### SUMMARY OF THE INVENTION

The present invention provides architecture for a scalable Internet engine that dynamically reassigns server operations in the event of a failure of an ADSS (Active Data Storage System) server. A first and a second ADSS server mirror each other and include corresponding databases with redundant data, domain host control protocol servers, XML interfaces and watchdog timers. The ADSS servers are communicatively coupled to at least one engine operating system and a storage switch; the storage switch being coupled to at least one storage element. The second ADSS server detects, via a heartbeat monitoring algorithm, the failure of the first ADSS server and automatically initiates a failover action to switch over functions to the second ADSS server. The architecture also includes a supervisory data management arrangement that includes a plurality of reconfigurable blade servers coupled to a star configured array of distributed management units.

In one embodiment of the present invention, an architecture for a scalable internet engine for providing dynamic reassignment of server operations in the event of a failure of a server includes at least one blade server operatively connected to an Ethernet switching arrangement and a first active data storage system (ADSS) server programmatically coupled to at least one blade server via the Ethernet switching arrangement. The first ADSS server comprises a first database that interfaces with a first Internet protocol (IP) address server that assigns an IP addresses within the architecture and a first ADSS module adapted to provide a directing service to a user, and a first XML interface daemon adapted to interface between an engine operating system and the first ADSS module. The architecture also includes a second (ADSS) server programmatically coupled to at least one blade server via the ethernet switching arrangement. The second ADSS server comprises a second database that interfaces with a second internet protocol (IP) address server adapted to assign IP addresses within the architecture upon failure of the first ADSS server; the second database also interfaces with a second ADSS module that provides data storage, drive mapping and a directory service to the user. The second database is programmatically coupled to the first database and includes redundant information from the first database. The second ADSS server also includes a second XML interface daemon adapted to interface between the second ADSS server and the engine operating system, wherein the engine operating system is also programmatically coupled to at least one supervisory data management arrangement. The engine operating system is configured to provide global management and control of the architecture of the scalable Internet engine. The second ADSS server is further adapted to detect a failure in the first ADSS server via a heartbeat monitoring circuit (and algorithm) and initiate a failover action to switchover the functions of the first ADSS server to the second ADSS server. The architecture also includes a storage switch programmatically coupled to the first and second servers and a disk storage arrangement coupled to the storage switch.

In another embodiment of the present invention, a supervisory data management arrangement adapted to interact within the architecture of a scalable internet engine includes a plurality of reconfigurable blade servers adapted to interface with distributed management units (DMUs), wherein each of the blade servers is adapted to monitor health and control power functions and is adapted to switch between individual blades within the blade server in response to a command from an input/output device. The supervisory data management arrangement also includes a plurality of distributed management units (DMUs), each distributed management unit being adapted to interface with at least one blade server and to control and monitor various blade functions as well as arbitrate management communications to and from the blades via a management bus and an I/O bus. Also included is a supervisory data management unit (SMU) adapted to interface with the distributed management units in a star configuration at the management bus and the I/O bus connection. The SMU is adapted to communicate with the DMUs via commands transmitted via management connections to the DMUs.

In a related embodiment, each blade is adapted to electronically disengage from a communications bus upon receipt of a signal that is broadcast on the backplane to release all blades. A selected blade is adapted to electronically engage the communications bus after all the blades are released from the communications bus.

In another related embodiment, the architecture further comprises a plurality of slave ADSS modules programmatically coupled to the supervisory data management arrangement, such that each of the ADSS modules visualizes the disk storage units and the individual blades. Hence, the ADSS servers provide distributed virtualization within the architecture by reconfiguring the mapping from between a first blade and a first slave ADSS module to between the first blade to a second slave ADSS module in response to an overload condition on any of the slave ADSS modules.

### BRIEF DESCRIPTION OF THE DRAWINGS

The invention may be more completely understood in consideration of the following detailed description of various embodiments of the invention in connection with the accompanying drawings, in which:

FIG. 1 is a block diagram depicting a simplified scalable Internet engine with replicated servers that utilizes the iSCSI boot drive of the present invention.

FIG. 2 is a flowchart depicting the activation/operation of the iSCSI boot drive of the present invention.

FIG. 3 is a block diagram depicting a server farm in accordance with the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

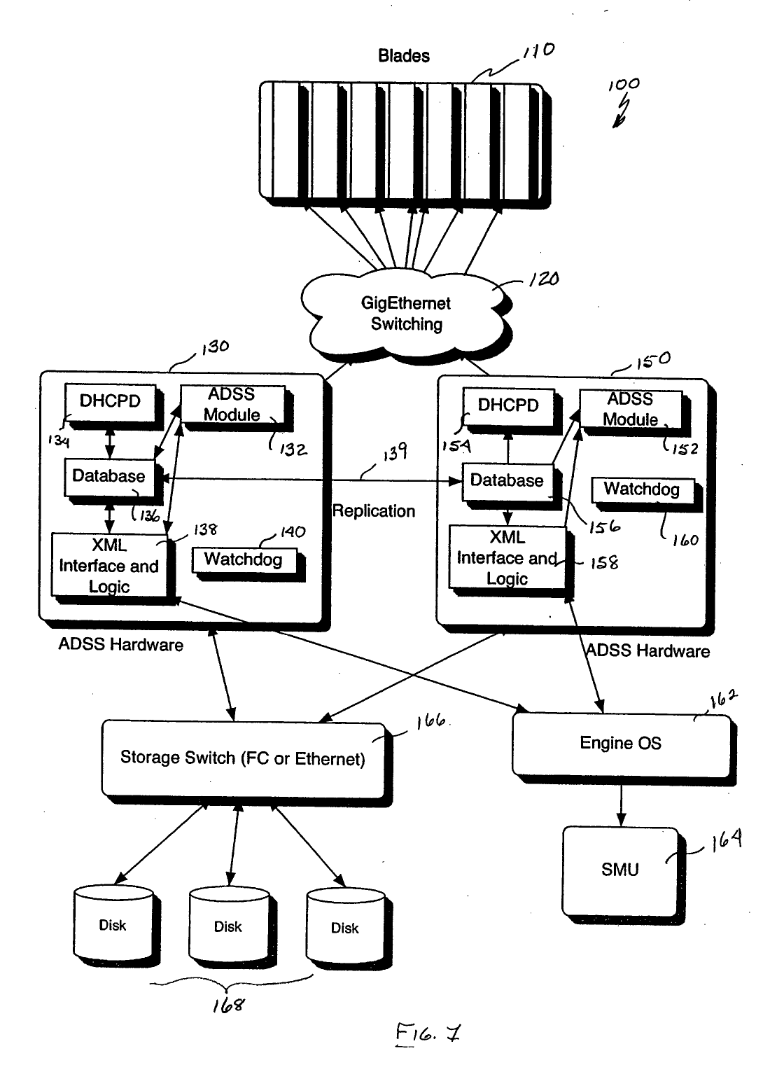

Referring to FIG. 1, an architecture 100 for a scalable Internet engine is defined by a plurality of server boards each arranged as an engine blade 110. Further details as to the physical configuration and arrangement of computer servers 110 within a scalable internet engine 100 in accordance with one embodiment of the present invention are provided in U.S. Pat. No. 6,452,809, entitled “Scalable Internet Engine,” which is hereby incorporated by reference, and the concurrently filed application entitled “iSCSI Boot Drive Method and Apparatus for a Scalable Internet Engine.” The preferred software arrangement of computer servers 110 is described in more detail in the previously referenced application entitled “Method and System for Providing Dynamic Hosted Services Management Across Disparate Accounts/Sites.”

The architecture of the present invention is further defined by two sets of hardware 130 and 150. Hardware 130 establishes the Active Data Storage System (ADSS) server that includes an ADSS module 132, a Dynamic Host Configuration Protocol (DHCPD) server 134, a database 136, an XML interface 138 and a watchdog timer 140. Hardware 130 is replicated by the hardware 150, which includes an ADSS module 152, a domain host control protocol server (DHCPD) 154, a database 156, an XML interface 158 and a watchdog timer 160. Both ADSS hardware 130 and ADSS hardware 150 are interfaced to the blades 110 via an ethernet switching device 120. Combined, ADSS hardware 130 and ADSS hardware 150 may be deemed a virtualizer, a system capable of selectively attaching virtual volumes to an initiator (e.g., client, host system, or file server that requests a read or write of data).

Architecture 100 further includes an engine operating system (OS) 162, which is operatively coupled between hardware 130, 150 and a system management unit (SMU) 164 and by a storage switch 166, which is operatively coupled between hardware 130, 150 and a plurality of storage disks 168. Global management and control of architecture 100 is the responsibility of Engine OS 162 while storage and drive mapping is the responsibility of the ADSS modules.

The ADSS modules 132 and 152 provide a directory service for distributed computing environments and present applications with a single, simplified set of interfaces so that users can locate and utilize directory resources from a variety of networks while bypassing differences among proprietary services; it is a centralized and standardized system that automates network management of user data, security and distributed resources, and enables interoperation with other directories. Further, the active directory service allows users to use a single log-on process to access permitted resources anywhere on the network while network administrators are provided with an intuitive hierarchical view of the network and a single point of administration for all network objects.

The DHCPD servers 134 and 154 operate to assign unique IP addresses within the server system to devices connected to the architecture 100, e.g., when a computer logs on to the network, the DHCP server selects a unique and unused IP address from a master list (or pool of addresses) that are valid on a particular network and assigns it to the system or client. Normally these addresses are assigned on a random basis, where a client looks for a DHCP server through means of an IP address-less broadcast and the DHCP responds by “leasing” a valid IP address to the client from its address pool. In the present invention, the architecture supports a specialized DHCP server which assigns specific IP addresses to the blade clients by correlating IP addresses with MAC addresses (the physical, unchangeable address of the Ethernet network interface card) thereby guaranteeing a particular blade client that the IP addresses are always the same since their MAC addresses are consistent. The IP address to MAC correlations is generated arbitrarily during the initial configuration of the ADSS, but remains consistent after this time. Additionally, the present invention utilizes special extended fields in the DHCP standard to send additional information to a particular blade client that defines the iSCSI parameters necessary for the blade client to find the ADSS server that will service the blade's disk requests and the authentication necessary to log into the ADSS server.

Referring back to FIG. 1, the databases 136 and 156, communicatively coupled to their respective ADSS module and DHCPD server, serve as the repositories for all target, initiator device addressing, available volume locations and raw storage mapping information as well as serve as the source of information for the respective DHCPD server. The databases are replicated between all ADSS server team members so that vital system information is redundant. The redundant data from database 136 is regularly updated on database 156 via a communications bus 139 coupling both databases. The XML interface daemons 138 and 158 serve as the interface between the engine operating system 162 and the ADSS hardware 130, 150. They serve to provide logging functions and to provide logic to automate the ADSS functions. The watchdog timers 140 and 160 are provided to reinitiate server operations in the event of a lock-up in the operation of any of the servers, e.g., a watchdog timer time-out indicates failure of the ADSS. The storage switch 166 is preferably of a Fiber Channel or Ethernet type and enables the storage and retrieval of data between disks 168 and ADSS hardware 130, 150.

Note that in the depicted embodiment of architecture 100, ADSS hardware 130 functions as the primary DHCP server unless there is a failure. In a related embodiment, a Bootstrap Protocol (BOOTP) server can also be used. A heartbeat monitoring circuit, forming part of 139, is incorporated into the architecture between ADSS hardware 130 and ADSS hardware 150 to test for failure. Upon failure of server 130, server 150 will detect the lack of the heartbeat response and will immediately begin providing the DHCP information. In a particularly large environment, the server hardware will see all storage available, such as storage in disks 168, through a Fiber channel switch so that in the event of a failure of one of the servers, another one of the servers (although only one other is shown here) can assume the functions of the failed server. The DHCPD modules interface directly with the corresponding database as there will be only one database per server for all of the IP and MAC address information of architecture 100.

In this example embodiment, engine operating system interface 162 (or Simple Web-Based interface) issues “action” commands via XML interface daemon 138 or 158, to create, change, or delete a virtual volume. XML interface 138 also issues action commands for assigning/un-assigning or growing/shrinking a virtual volume made available to an initiator, as well as issuing checkpoint, mirror, copy and migrate commands. The logic portion of the XML interface daemon 138 also receives “action” commands involving: checks for valid actions; converts into server commands; executes server commands; confirms command execution; roll back if failed command; and provides feedback to the engine operating system 162. Engine operating system 162 also issues queries for information through the XML interface 138 with the XML interface 138 checking for valid queries, converting XML queries to database queries, converting responses to XML and sending XML data back to operating system 162. The XML interface 138 also sends alerts to operating system 162, with failure alerts being sent via the log-in server or the SNMP.

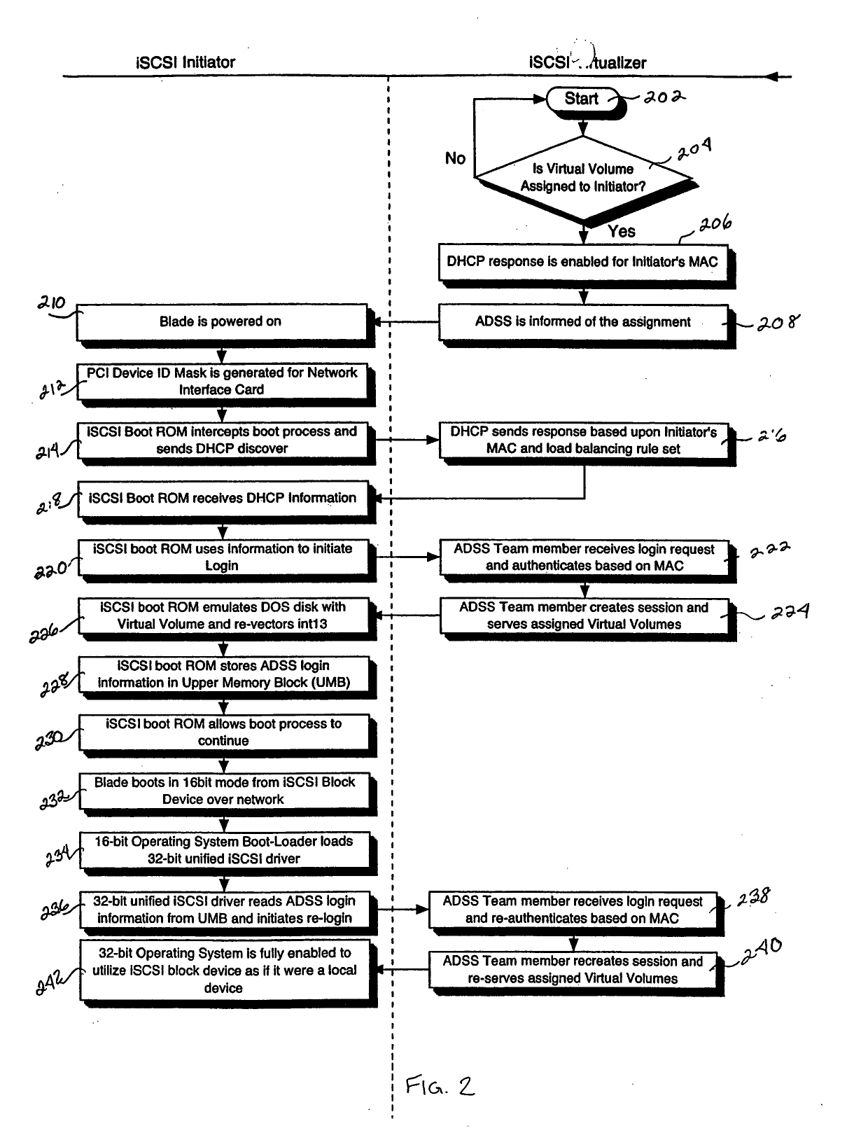

In view of the above description of the scalable Internet engine architecture 100, the login process to the scalable Internet engine may now be understood with reference to the flow chart of FIG. 2. Login is established through the use of iSCSI bootdrive, wherein the operations enabling the iSCSI bootdrive are divided between an iSCSI Virtualizer (ADSS hardware 130 and ADSS hardware 150 comprising the virtualizer), see the right side of the flow chart of FIG. 2, and an iSCSI Initiator, see the left side of the flow chart of FIG. 2. The login starts with a request from an initiator to the iSCSI virtualizer, per start block 202. The iSCSI virtualizer then determines if a virtual volume has been assigned to the requesting initiator, per decision block 204. If a virtual volume has not been assigned, the iSCSI virtualizer awaits a new initiator request. However, if a virtual volume has been assigned to the initiator the login process moves forward whereby the response from DHCP server 134 is enabled for the initiator's MAC (media access control) address, per operations block 206. Next, the ADSS module 132 is informed of the assignment of the virtual volume in relation to the MAC, per operations block 208 and communicates to power on the appropriate engine blade 110, per operations block 210 of the iSCSI initiator.

Next, a PCI (peripheral component interconnect) device ID mask is generated for the blade's network interface card thereby initiating a boot request, per operations block 212. Note that a blade is defined by the following characteristics within the database 136: (1) MAC address of NIC (network interface card), which is predefined; (2) IP address of initiator (assigned), including: (a) Class A Subnet [255.0.0.0] and (b) 10.[rack].[chassis].[slot]; and (3) iSCSI authentication fields (assigned) including: (a) pushed through DHCP and (b) initiator name. Pushing through DHCP refers to the concept that all iSCSI authentication fields are pushed to the client initiator over DHCP. More specifically, all current iSCSI implementations require that authentication information such as username, password, IP address of the iSCSI target which will be serving the volume, etc., be manually entered into the client's console through the operating system utility software. Hence, this is why current iSCSI implementations are not capable of booting because this information is not available until an operating system and respective iSCSI software drivers have loaded and either read preset parameters or had manual intervention from the operator to enter this information.

By pushing this information through the DHCP we then not only have a method to make this information available to the client (initiator) at the pre-OS stage of the boot process but we also create a central authority (the ADSS in our system) that stores and dynamically changes these settings to facilitate various operations. With this approach, operations such as failing over to an alternate ADSS unit or adding or changing the number and size of virtual disks mounted on the client occur without any intervention from the client's point of view.

As described more fully in the application entitled, “iSCSI Boot Down Method and Apparatus for a Scalable Internet Engine,” the iSCSI Boot ROM intercepts the boot process and sends a discover request to the DHCP SERVER 134, per operations block 214. The DHCP server sends a response to the discover request based upon the initiator's MAC and, optionally, a load balancing rule set, per operations block 216. Specifically, the DHCP server 134 sends the client's IP address, netmask and gateway, as well as iSCSI login information: (1) the server's IP address (ADSS's IP); (2) protocol (TCP by default); (3) port number (3260 by default); (4) initial LUN (logical unit number); (5) target name, i.e., ADSS server's iSCSI target name; and (6) initiator's name.

With respect to the load balancing rule set option for the DHCP server, certain ADSS units are selected first to service a client's needs where their servicing load is light. Load balancing in the context of the present architecture of the ADSS system involves the two master ADSS servers that provide DHCP, database and management resources and are configured as a cluster for fault tolerance of the vital database information and DHCP services. The architecture also includes a number of “slave” ADSS, workers which are connected to and are controlled by the master ADSS server pair. These slave ADSS units simply service virtual volumes. Load balancing is achieved by distributing virtual volume servicing duties among the various ADSS units through a round robin process following a least connections priority model in which the ADSS servicing the least number of clients is first in line to service new clients. Class of service is also achieved through imposing or setting limits on the maximum number of clients that any one ADSS unit can service, thereby creating more storage bandwidth for the clients that use the ADSS units with the upper limit setting versus those that operate on the standard ADSS pool.

Referring back to FIG. 2, the iSCSI Boot ROM next receives the DHCP server 134 information, per operations block 218, and uses the information to initiate login to the blade server, per operations block 220. The ADSS module 132 receives the login request and authenticates the request based upon the MAC of the incoming login and the initiator name, per operations block 222. Next, the ADSS module creates the login session and serves the assigned virtual volumes, per operations block 224. The iSCSI Boot ROM emulates a DOS disk with the virtual volume and re-vectors Int13, per operations block 226. The iSCSI Boot ROM stores ADSS login information in its Upper Memory Block (UMB), per operations block 228. The iSCSI Boot Rom then allows the boot process to continue, per operations block. 230.

As such, the blade boots in 8-bit mode from the iSCSI block device over the network, per operations block 232. The 8-bit operating system boot-loader loads the 32-bit unified iSCSI driver, per operations block 234. The 32-bit unified iSCSI driver reads the ADSS login information from UMB and initiates re-login, per operations block 236. The ADSS module 132 receives the login request and re-authenticates based on the MAC, per operations block 238. Next, the ADSS module recreates the login session and re-serves the assigned virtual volumes, per operations block 240. Finally, the 32-bit operating system is fully enabled to utilize the iSCSI block device as if it were a local device, per operations block 242.

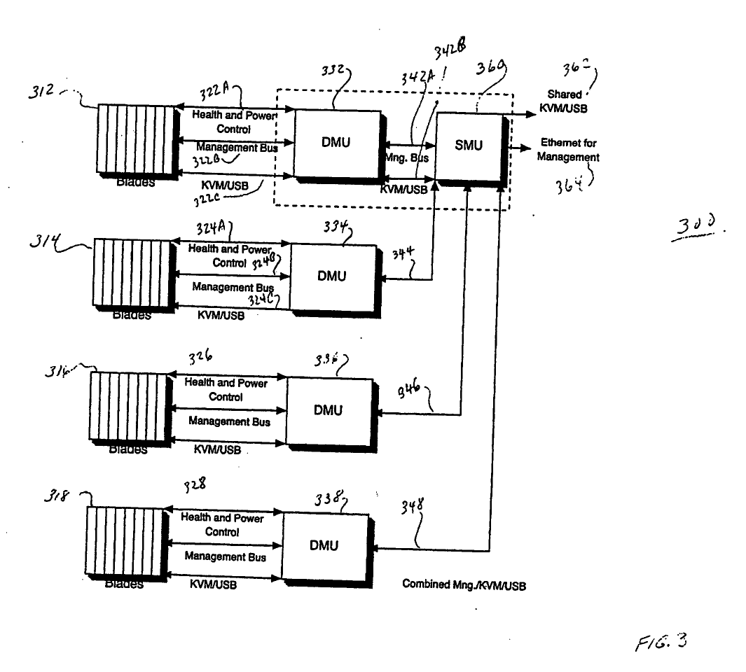

Referring now to FIG. 3, there is illustrated a supervisory data management arrangement 300 adapted to form part of architecture 100. Supervisory data management arrangement 300 comprises a plurality of reconfigurable blade servers 312, 314, 316, and 318 that interface with a plurality of distributed management units (DMUs) 332-338 configured in a star configuration, which in turn interface with at least one supervisory management unit (SMU) 360. SMU 360 includes an output 362 to the shared KVM/USB devices and an output 364 for Ethernet Management.

In this example embodiment, each of blade servers chassis 312-318 (four) comprise 8 blades disposed within a chassis. Each DMU module monitors the health of each of the blades and the chassis fans, voltage rails, and temperature of a given chassis of the server unit via communication lines 322A, 324A, 326A and 328A. The DMU also controls the power supply functions of the blades in the chassis and switches between individual blades within the blade server chassis in response to a command from an input/output device (via communication lines 322B, 324B, 326B, and 328B). In addition, each of the DMU modules (332, 334, 336, and 338) is configured to control and monitor various blade functions and to arbitrate management communications to and from SMU 360 with respect to its designated blade server via a management bus 332A and an I/O bus 322B. Further, the DMU modules consolidate KVM/USB output and management signals into a single DVI type cable, which connects to SMU 360, and maintain a rotating log of events.

In this example embodiment, each blade of each blade servers includes an embedded microcontroller. The embedded microcontroller monitors health of the board, stores status on a rotating log, reports status when polled, sends alerts when problems arise, and accepts commands for various functions (such as power on, power off, Reset, KVM (keyboard, video and mouse) Select and KVM Release). The communication for these functions occurs via lines 322C, 324C, 326C and 328C.

SMU 360 is configured, for example, to interface with the DMU modules in a star configuration at the management bus 342A and the I/O bus 342B connection. SMU 360 communicates with the DMUs via commands transmitted via management connections to the DMUs. Management communications are handled via reliable packet communication over the shared bus having collision detection and retransmission capabilities. The SMU module is of the same physical shape as a DMU and contains an embedded DMU for its local chassis. The SMU communicates with the entire rack of four (4) blade server chassis (blade server units) via commands sent to the DMUs over their management connections 342-348). The SMU provides a high-level user interface via the Ethernet port for the rack. The SMU switches and consolidates KVM/USB busses and passes them to the Shared KVM/USB output sockets.

Keyboard/Video/Mouse/USB (KVM/USB) switching between blades is conducted via a switched bus methodology. Selecting a first blade will cause a broadcast signal on the backplane that releases all blades from the KVM/USB bus. All of the blades will receive the signal on the backplane and the previous blade engaged with the bus will electronically disengage. The selected blade will then electronically engage the communications bus.

In the various embodiments described above, an advantage of the proposed architecture is the distributed nature of the ADSS server system. Although another known system provides a fault tolerant pair of storage virtualizers with a failover capability but no other scaling alternatives, the present invention advantageously provides distributed virtualization such that any ADSS server is capable of servicing any Client Blade because all ADSS units can “see” all Client Blades and all ADSS units can see all RAID storage units where the virtual volumes are stored. With this capability, Client Blades can be mapped to any arbitrary ADSS unit on demand for either failover or redistribution of load. ADSS units can then be added to a current configuration or system at any time to upgrade the combined bandwidth of the total system.

A portion of the disclosure of this invention is subject to copyright protection. The copyright owner permits the facsimile reproduction of the disclosure of this invention as it appears in the Patent and Trademark Office files or records, but otherwise reserves all copyright rights.

Although the preferred embodiment of the automated system of the present invention has been described, it will be recognized that numerous changes and variations can be made and that the scope of the present invention is to be defined by the claims.

1. An architecture for a scalable Internet engine for providing dynamic reassignment of server operations in the event of a failure of a server, the architecture comprising:
at least one blade server operatively connected to an ethernet switching arrangement;
a first active data storage system (ADSS) server programmatically coupled to the at least one blade server via the ethernet switching arrangement, the first ADSS server comprising:
a first database adapted to interface with a first internet protocol (IP) address server adapted to assign IP addresses within the architecture and a first ADSS module adapted to provide a directory service to a user; and
a first XML interface daemon adapted to interface between an engine operating system and the first ADSS module;
a second active data storage system (ADSS) server programmatically coupled to the at least one blade server via the ethernet switching arrangement, the second ADSS server comprising:
a second database adapted to interface with a second internet protocol (IP) address server adapted to assign IP addresses within the architecture upon failure of the first ADSS server, the second database also adapted to interface with a second ADSS module adapted to provide the directory service to the user, wherein the second database is programmatically coupled to the first database and includes redundant information from the first database; and
a second XML interface daemon adapted to interface between the second ADSS module and the engine operating system, wherein the second ADSS server is adapted to detect a failure in the first ADSS server, via a heartbeat monitoring circuit connected to the first ADSS server, and initiate a failover action that switchovers the functions of the first ADSS server to the second ADSS server;
at least one supervisory data management arrangement programmatically coupled to the engine operating system and adapted to be responsive to the first and second ADSS modules;
a storage switch programmatically coupled to the first and second ADSS servers; and
a disk storage arrangement coupled to the storage switch.

2. The architecture of claim 1, wherein the first and second IP address servers utilize a communications protocol selected from the group consisting of a Dynamic Host Configuration Protocol (DHCP) and a Bootstrap Protocol (BOOTP).

3. The architecture of claim 1, wherein the first and second databases store target and initiator device addresses, available volume locations and storage mapping information.

4. The architecture of claim 1, wherein each of the first and second ADSS servers further include a watchdog timing circuit, respectively, to reinitiate the server.

5. The architecture of claim 1, wherein the supervisory data management arrangement is adapted to process commands from the first and second ADSS servers to alter mapping to a plurality of slave ADSS servers.

6. The architecture of claim 1, wherein the supervisory data management arrangement comprises a supervisory data management unit (SMU) that interfaces with a plurality of data management units (DMU) in a star configuration, wherein each DMU interfaces with a plurality of reconfigurable blade servers.

7. The architecture of claim 1, further comprising a plurality of slave ADSS servers that are communicatively connected to and controlled by the first and second ADSS servers, wherein the slave ADSS servers are adapted to service virtual volume duties of the architecture via a round robin scheme.

8. The architecture of claim 1, further comprising a plurality of ADSS slave servers adapted to visualize any client blade and any RAID storage unit storing virtual volumes such that the ADSS slave servers are adapted to service any client blade, wherein the plurality of ADSS slave servers increase the combined bandwidth of the architecture so as to achieve distributed virtualization.

9. The architecture of claim 8, wherein any client blade is adapted to be mapped to any ADSS slave server on demand as a function of a predefined condition that includes a failover and a redistribution of load.

10. The architecture of claim 1, wherein the ADSS modules are further adapted to automate management of user data and facilitate a single log-on process so as to permit access to authorized resources throughout the architecture.

11. A supervisory data management arrangement adapted to interact within the architecture of a scalable Internet engine, the supervisory data management arrangement comprising:
a plurality of reconfigurable blade servers adapted to interface with data management units (DMUs), each of said blade servers adapted to monitor health, control and power functions and switch between individual blades within each blade server in response to a command from an input/output (I/O) device;
a plurality of data management units (DMUs), each data management unit adapted to interface with at least one blade server and to control and monitor various blade functions, the data management unit further adapted to arbitrate management communications to and from the blade server via a management bus and an I/O bus; and
a supervisory data management unit (SMU) adapted to interface with the data management units in a star configuration at the management bus and the I/O bus connection, wherein the SMU is adapted to communicate with the DMUs via commands transmitted via management connections to the DMUs.

12. The data management arrangement of claim 11, wherein each blade within each reconfigurable blade server is connected to a communications bus and is adapted to electronically disengage from the communications bus upon receipt of a signal to release all blades, and wherein the release signal is broadcast on a backplane supporting the blades.

13. The data management arrangement of claim 12, wherein a selected blade is adapted to electronically engage the communications bus after all the blades are released from the communications bus.

14. The data management arrangement of claim 11, wherein the SMU further comprises a first output configured for I/O devices and a second output configured for Ethernet management.

15. The data management arrangement of claim 11, wherein each of the blade servers comprises a plurality of blades, each of the blades comprising a microcontroller mounted on a circuit board adapted to monitor health of the circuit board, store status of the blade on a rotating log, report blade status when polled and accept commands for a plurality of blade functions.

16. The data management arrangement of claim 11, wherein each DMU is adapted to monitor the health and control the power supply function of the blades.

17. The data management arrangement of claim 16, wherein each DMU is further adapted to switch between individual blades within the blade server in response to a command from an I/O device.

18. An architecture for a scalable internet engine for providing dynamic reassignment of server operations in the event of a redistribution of a load, the architecture comprising:
at least one blade server operatively connected to an ethernet switching arrangement, the blade server comprised of a plurality of individual blades;
a first active data storage system (ADSS) server programmatically coupled to the at least one blade server via the ethernet switching arrangement, the first ADSS server including a first database that interfaces with an first internet protocol (IP) address server and a first ADSS module that provides a directory service to a user, and a first XML interface daemon that interfaces between an engine operating system and the first ADSS module;
a second active data storage system (ADSS) server programmatically coupled to the at least one blade server via the ethernet switching arrangement, the second ADSS server including a second database that interfaces with a second IP address server that assigns IP addresses upon failure of the first ADSS server, the second database adapted to interface with a second ADSS module and to interface with the first database so as to include redundant information from the first database, and a second XML interface daemon that interfaces between the second ADSS module and the engine operating system;
at least one supervisory data management arrangement programmatically coupled to the engine operating system and adapted to be responsive to the first and second ADSS modules;
a storage switch programmatically coupled to the first and second ADSS servers;
a plurality of disk storage units coupled to the storage switch; and
a plurality of slave ADSS modules programmatically coupled to the supervisory data management arrangement, each of the ADSS modules adapted to visualize the disk storage units and the individual blades, wherein the ADSS servers are adapted to provide distributed virtualization within the architecture by reconfiguring the mapping from between a first blade and a first slave ADSS module to between the first blade to a second slave ADSS module in response to an overload condition on any of the slave ADSS modules.

19. The architecture of claim 18, wherein the IP address servers are configured to utilize extended fields in the DHCP standard to transmit the iSCSI parameters to a selected individual blade so as to find the associated ADSS server that will service the disk and the log-in authentication needs of the individual blade.

20. The architecture of claim 18, wherein the supervisory data management arrangement is comprised of a plurality of reconfigurable blade servers, each blade within each reconfigurable server is supported on a backplane and is adapted to electronically disengage from a communications bus upon receipt of a signal to release all blades, wherein a selected blade is adapted to electronically engage the communications bus after all the blades are released from the communications bus.
